(19) United States
(12) Patent Application Publication
(10) Pub. No.: US 2010/0017890 A1
(43) Pub. Date: Jan. 21, 2010

(54) Symbol Based Cipher Code Registration System and Method

(76) Inventors: Amy Tucker, Seattle, WA (US); Chris Stevens, Seattle, WA (US)

Correspondence Address: Jellett Law, PS;Matthew Jellett, Esq., 910 Harris Ave, Suite A205, BELLINGHAM, WA, 98225, US

(21) Appl. No.: 12/504,650

(22) Filed: Jul. 16, 2009

Related U.S. Application Data
(60) Provisional application No. 61/081,210, filed on Jul. 16, 2008.

(51) Int. Cl. G06F 7/04; G06K 19/06

(52) U.S. Cl. 726/28; 235/494; 235/487

(57) ABSTRACT

A symbol cipher system. The system has a symbol cipher application for execution on a digital platform. The symbol cipher application has: a first group of symbol components; a first range of code entry fields; a cipher correlation table. The cipher correlation table correlates the first group of symbol components to a first range of language characters. The first group of symbol components can be entered into the first range of code entry fields for registration of a symbol information item in an application database.

### RELATED APPLICATIONS

This application claims priority benefit and hereby incorporates by reference U.S. Ser. No. 11/674,010, filed Feb. 12, 2007. This application further claims priority benefit of U.S. Ser. No. 61/081210, filed Jul. 16, 2008.

### BRIEF DESCRIPTION OF THE DRAWINGS

FIG. 1 is a schematic diagram of the overall system;

FIG. 2 is a schematic diagram of the interface showing the home page;

FIG. 3 is a schematic diagram of the interface showing the code cracker;

FIG. 4 is a schematic diagram of the interface showing the field book;

FIG. 5 is a schematic diagram of the interface showing the activities;

FIG. 6A is a schematic flow chart of the method for decoding a symbol information item;

FIG. 6B is a continuation of the above schematic flow chart in FIG. 6A;

FIG. 7 is a schematic flow chart of the method for encoding a symbol information item.

### DESCRIPTION OF THE PREFERRED EMBODIMENTS

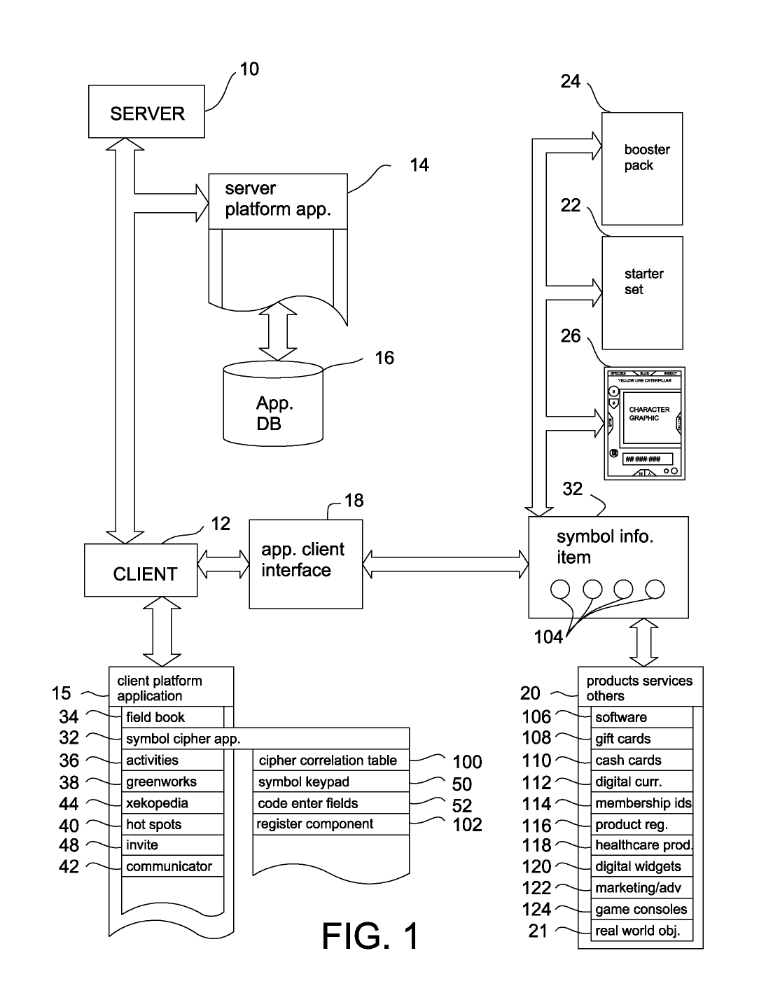

What is generally provided is an open system model which combines site content, user generated content, social networking content, and real world results into an application client interface 18 FIG. 1, which works in conjunction with the client computer 12, which has interactive communication with the remote or local application server 10. The application server hosts a game or site application 14 which is supported by an application database 16.

Each client 12 can become a part of a crowd sourcing model, where user participants through their application client interfaces 18 can be recognized, rewarded and contribute challenges or perform challenges to build community as the users earn points, level up, and develop within the open system model.

This open system model enables users to be trained, communicate, and utilize the tool components in order to complete missions or challenges, as well as contribute their own unique challenges to the open model system, and build agent networks which can be social networks enabling the user generated content to drive some of the development of the open system model. The users interact with various real world physical services and objects which provide for increased interaction between physical objects and the open model system. For example, users may have access to physical real-world objects 21, products and services of others 20, trading card game starter sets 22, trading card game booster pack sets 24, and individual trading card components 26.

The products and services of others 20 also includes software items 106, gift cards 108, cash cards 110, digital currency 112, and other items which may be purchased as software or monetary exchange over the Internet. Additionally, membership ID's 114 may be accessible, hack-proofing registration components 116, healthcare products 118, digital widget's 120, marketing/promotional components 122, game consoles 124, and game cards which may interoperate with game consoles.

The main core activities of the open model system include managing a field or dossier book; completing challenges; building agent networks; creating challenges; spending credits or points; reviewing ecological and species information through the use of an encyclopedia.

These main components or core activities are embodied as executable platform components through a client application 15 which is resident on the client 12. These platform applications 14 are coded in PHP and draw from the SQL server database 16 which has been developed in this particular embodiment, as a flash application in the form of the client application 15 for execution on the client 12. The sub applications executable within the client application include as will be discussed in further detail below, field book application 34, an activities application 36, a green works application 38, a xeko PDA application 44, a hot spots application 40, an invite application 48, a communicator application 42, and a symbol cipher application 32. The symbol cipher application includes a cipher correlation table 100, a symbol keypad 50, a code enter field range 52, and a register component 102. Briefly, a symbol information item 31 as will be discussed in more detail below, maybe one or more of the above discussed products/services of others 20, starter set 22, booster pack 24, or card component 26. Located or encoded onto the symbol information item 31 will be a first group of symbol information characters 104.

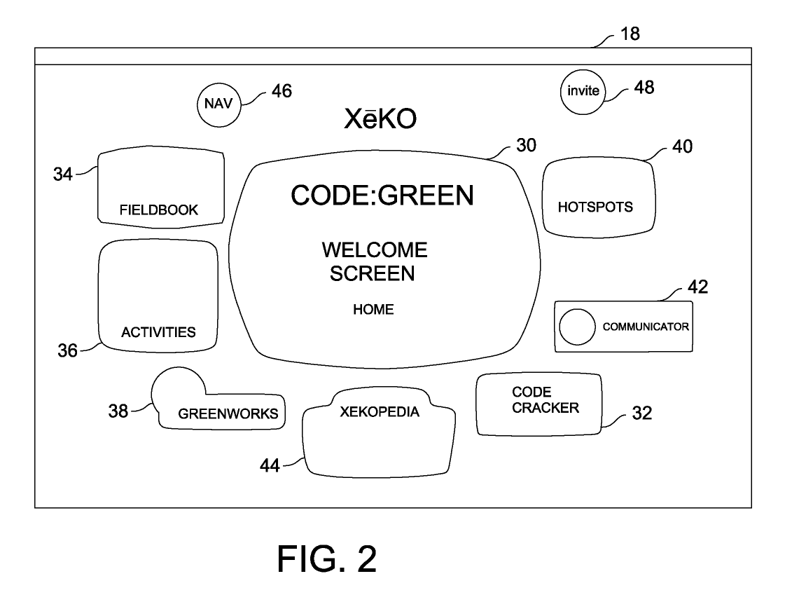

Referring to FIG. 2, a discussion of the instances of the various components as executed at the application client interface 18 of the client application 15 will now be provided.

Various components executed at the client interface application 18 include a home screen 30 with a navigational component 46 and an invitation component 48. A field book component 34 which will be discussed further below, provides for user logging of various awards and activities. The activities component 36 enables the user within his or her account to create and play activities as discussed below. The green works component is an ecological friendly recycling program teaming with its partner activities and special events. The xekopedia component is an online encyclopedia or resource of species and ecological sensitive hotspot areas.

The instance of the code cracker 32 or symbol cipher application 32, is part of a symbol registration system where the symbol cipher application 32 enables users to decode a series of symbols from the symbol information item 31 (FIG. 1) through entering of the symbols into a code enter field range 52 and simultaneously register the symbol information item 31 with the platform application 14 recorded in the application database 16.

By registering the symbol information item through this symbol based registration system, users can for example, obtain points for credits, within the system, enabling them to obtain additional products, access events, perform various “green works”, and access platform promotions or challenges within the platform application 14. A detailed discussion of the symbol cipher application will be provided below.

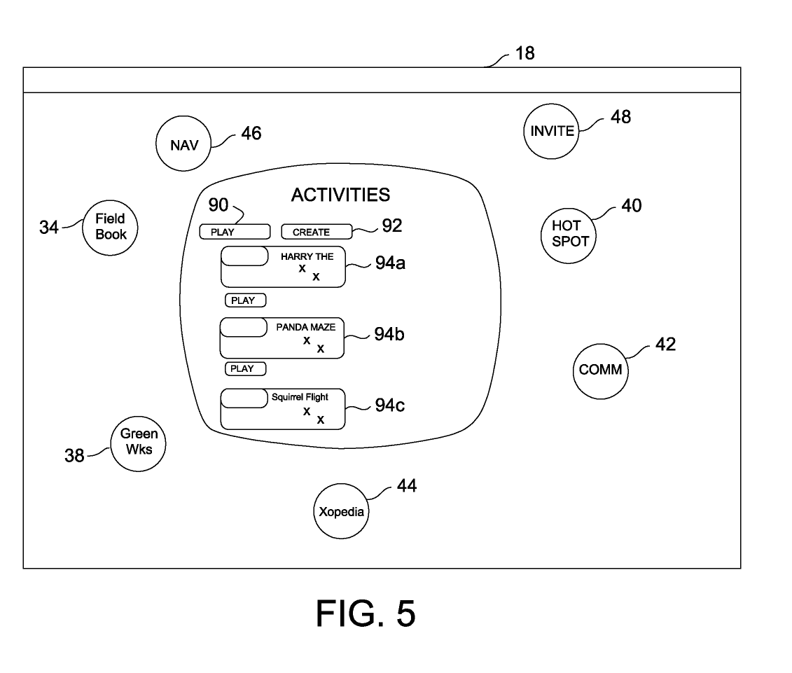

The communicator component 42 enables the user to communicate securely with other agents within the open model system. The hotspot component 40 includes site sponsored challenges for the users which are specific to each environmental hotspot. Users of the system obtain points for completion of each hotspot mission activity as well as game points when the full mission is completed. The users may also receive a mission stamp or badge 62 in their field book 34 as seen in FIG. 4, for each mission completed.

Furthermore, the hotspot missions may be an extension of the game system as seen in the resource sensitive game system and method having U.S. publication number U.S.-2008 0036150 published on Feb. 14, 2008, fully incorporated herein by reference.

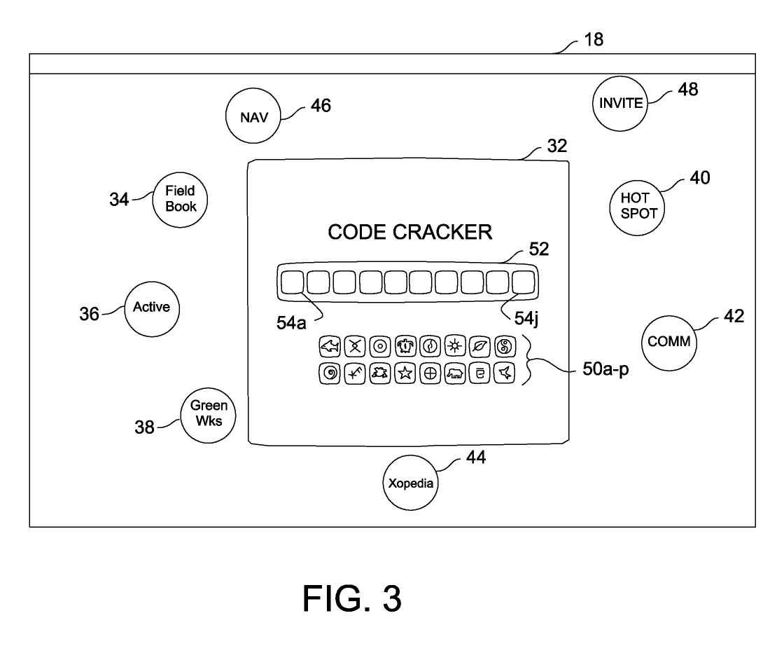

Referring to FIG. 3, a discussion of the symbol cipher application 32 or in other words the code cracker component will now be provided. The symbol cipher application 32 may be a application directly coded into a website, or it may be a downloadable plug-and-play software application such as a Java applet for inclusion into third-party websites. Nonetheless, the application may be executed on any digital platform.

The user may have received a symbol information item 31 which in this particular embodiment may be the previously mentioned physical real-world objects 21, products or services of others 20, starter sets 22, booster packs 24, card components 26, digital currency 112, gift cards 108, cash cards 110, software items or programs 106, digital widgets 120 from a social networking site etc. Located on the symbol information 31, may be a first group of symbol information characters 104. These symbol information characters 104, correlate to a series of symbol components 50A through 50B as seen in FIG. 3 of the symbol cipher application 32.

Coded within the symbol cipher application 32 is a cipher correlation table 100 (FIG. 1) which correlates the symbol components to a range of language characters which in this particular embodiment may be alphanumeric language characters for the English language. Other language characters are readily envisioned. For example this non exclusive list may include Chinese language characters, Japanese language characters, German language characters, French language characters, Arabic language characters, may all be represented in the range of language characters of the cipher correlation table 100.

These range of language characters are configured to be entered into the code enter field range 52 which has a series of symbol character fields 54A through 54J as seen in this particular embodiment.

As mentioned above, the user may have received a symbol information item 31. A symbol cipher system is used to encode a symbol information item and subsequently decode the symbol information item once the user has received the item.

To encode the symbol information item a graphic software application may be used to generate a group of symbol characters. An item or product code correlation table is created and maintained in the application database 16. A group of symbol information characters are assembled along with a series of unique codes which are then sent to a symbol information item provider in the item code correlation table.

This symbol information item provider may be a product manufacture, a software provider, a financial institution, a pharmaceutical provider, a marketing provider, a gaming provider, or other type of provider who offers products or services either in the physical sense or in the online realm.

The symbol information item provider then encodes the symbol information characters which are correlated to the item codes onto the symbol information item 31. The user then receives or purchases the item which then can be securely registered through the symbol cipher application.

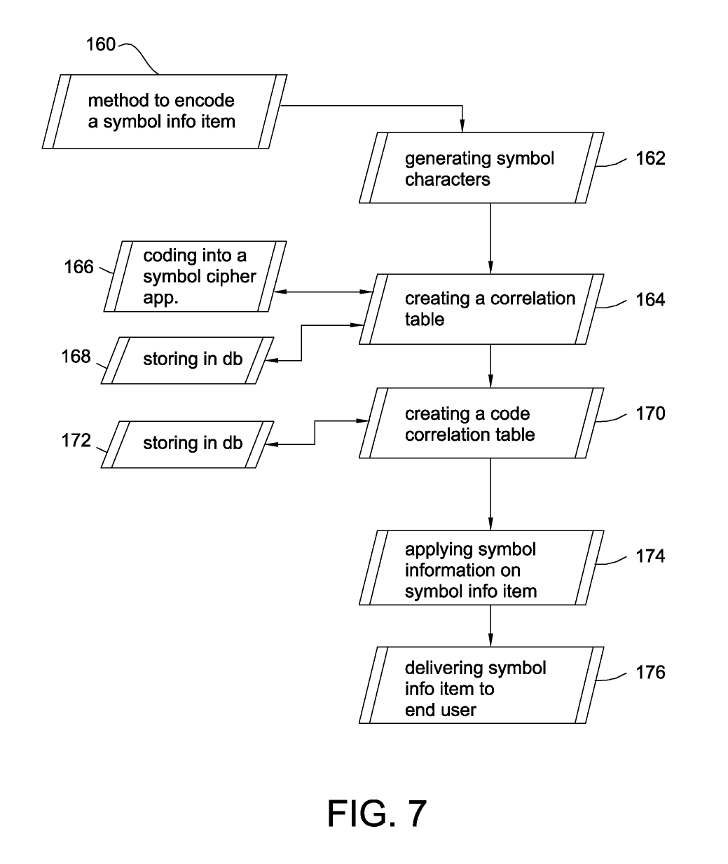

A detailed discussion of the method to code a symbol information item 160 as seen in FIG. 7 will now be provided. In order to provide a user with a symbol information item 32, the item itself must be coded with the symbol information for presentment to the user. At step 162, the method includes generating symbol characters by using a graphic software application. These symbol characters are then used for the symbol components within the symbol cipher application 32. The next step is creating a correlation table for the symbol characters to be correlated to the language characters at step 164. This correlation table is then coded into the symbol cipher application at step 166, and is stored or maintained in the application database at step 168.

Next an item code correlation table is created at step 170 which includes creating item codes for future items, and correlating the item codes to the symbol information which is made up of the symbol characters for storing in the application database at step 172.

The item code correlation table is then provided to the symbol information item provider for encoding the symbol information item with the symbol info itself at step 174. For example, a financial digital currency provider may issue certain digital currency accounts. In lieu of providing an account number, a symbol information code is provided when the account is created.

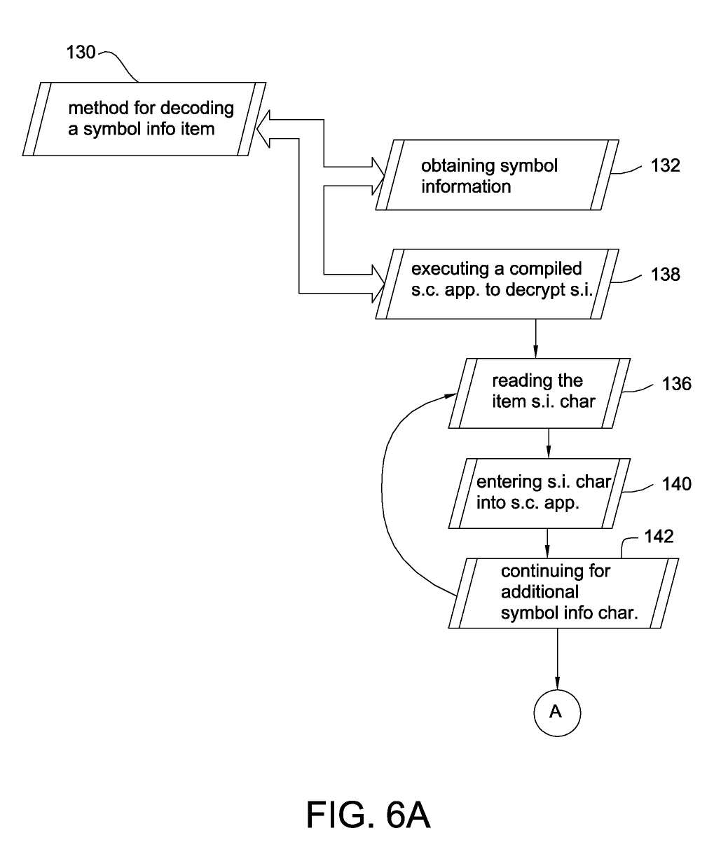

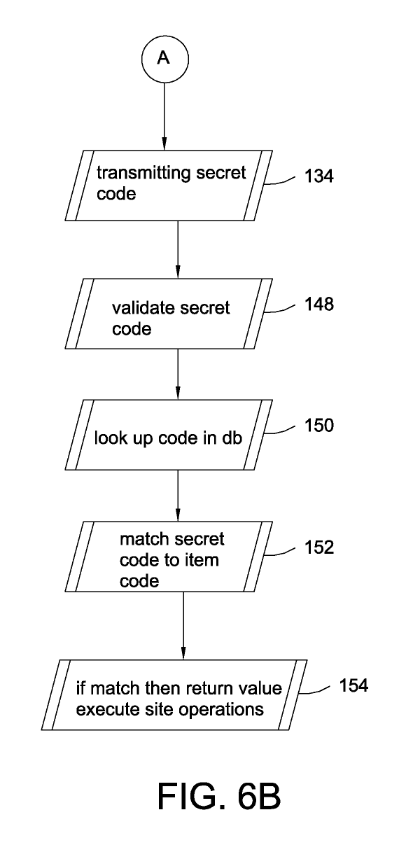

A detailed discussion of the method for decoding a symbol information item at step 130 as seen in FIGS. 6A and 6B will now be provided. A user may obtain a symbol information item at step 132 through the previously mentioned delivery of a symbol information item to an end user from a symbol information item provider. The symbol information item as previously discussed has a first group of symbol information character components 104 (FIG. 1) which have been applied to the symbol information item 31 (FIG. 1).

The user will execute a compiled symbol cipher application which is available through the user's digital platform. For example the digital platform may be a cash machine such as an ATM network, a console gaming network, cellular phone network supporting for example an iPhone application, mobile device platform running on for example a satellite network, a personal computer or laptop accessing the Internet through a wireless network, a local area network, a cable Internet provider, local area wireless Internet provider, DSL Internet provider, all enabling the attached clients which include the previously mentioned computers, mobile devices, cell phones, laptops, onboard aviation and automobile computers, and other smart technology clients to run digital platforms which can execute the symbol cipher application.

As previously mentioned, the symbol cipher application has a first group of symbol components which include digital representations of the symbol characters and where the symbol components are enabled to operate within the symbol cipher application. The symbol cipher application also has a first range of code enter fields. These fields are configured to display the symbol characters entered by the symbol components. A cipher correlation table is coded into the symbol cipher application for correlating the first group of symbol components with a first range of language characters. As previously discussed, the language characters can be alphanumeric English language, or non-English language characters as discussed above.

The user will read the symbol information character components 104 from the symbol information item at step 136 and then the user can enter the symbol information characters at step 140 into the symbol cipher application. The user can do this by first entering a first symbol component into one of the code entry fields 54A through 54J by graphically matching the first symbol information character to a first symbol component 50A through 50P as seen in FIG. 3.

The user can continue then to enter the symbol information character components at step 142 into the symbol cipher application until the range of code enter fields 54A through 54J have been filled with the appropriate symbol information characters which match the symbol information character components from the symbol information item.

At step 144 the user can transmit from the client digital platform 15 to the server platform application 14 the language characters which are correlated to the range of symbol information characters in the range of code enter fields. The first group of language characters define a secret code which must be proven valid on the platform application side through validation in the database 16.

The secret code is transmitted to the platform application 14 as seen in FIG. 1, and the secret code is validated at step 148 by first looking up the secret code in the application database at step 150, and next matching the secret code to an item code in the application database at step 152. The item code is maintained in the application database and is held in the item code correlation table where the item code is matched to the symbol information characters as previously discussed. If the secret code matches the item code in the item code correlation table, a validation value is returned to the user or the code is registered in the database to execute platform operations at step 154.

As previously indicated, the platform operations may include the following: enabling a registered user to use online activities, enabling a registered user to build social networks, create activities, spend credits or points, or enable the user to have access to additional platform information and features. Such additional platform features may include enabling the registered user to utilize digital currency online.

Furthermore, symbol information items can be obtained through events, demonstrations, leagues, tournaments, marketing activities, other partners, booster pack returns, special events, partner activities, promotions such as National Geographic, eco-lights, and eco-snacks. Furthermore, other products or services which may generate challenges may be direct point generators such as micro-challenges from the site application, partner challenges, or viral widgets sites such as my space or face book.

Now referring to FIG. 4, discussion of the field book 34 will now be provided. The field book is generated when a new user registers. The user obtains an agent ID and a picture can be chosen as an altar ego to the user. The user is rated on a level, based on the experience of the user. Points and messages can be reviewed and read through the field book interaction component.

As previously discussed, the badges component 62 shows the challenges or activities 70 which the user has completed and for which the user has received a reward. The Digital cards component 64 shows the miniature digital cards which have been played within the game system. These miniature Digital cards are linked to the actual card components in the database. The gifts component includes items which are received or purchased with points redeemed from use of the system. The cause component enables the user to spend his or her points or donate points to a particular event or affiliate. The agent network component 82 are the online friends which the user has affiliated with. The activities component 70 includes the list of challenges and links to various system provided and user provided challenges.

The challenges include a variety of activities ranging from quizzes, games, polls, contests, and real activities or events. The challenges generate points or symbols which then can be entered into the code cracker 32 for generation or redeeming points. Any user of the system can sponsor or create challenge. Users are provided with challenge tools to create other challenges based on the merit system. The higher an individual or user performs, the more tools and information to user has access to. Various challenges can be linked together to form challenge rings. These rings can create point incentives or perhaps they increase the ease of information flow. A leaderboard component lists and links top players networks to one another. The tools include an open challenge option; quiz maker; poll maker; ad lib component; flavor text scramblers; a maze maker; concentration game; etc. The completed component 72 lists the activities which the users completed, and the created component 74 lists the challenges that the users create. The expand component 78 enables the user to fully view everything in the field book 34. The hide component 80 enables user to close all the fields within the field book 34.

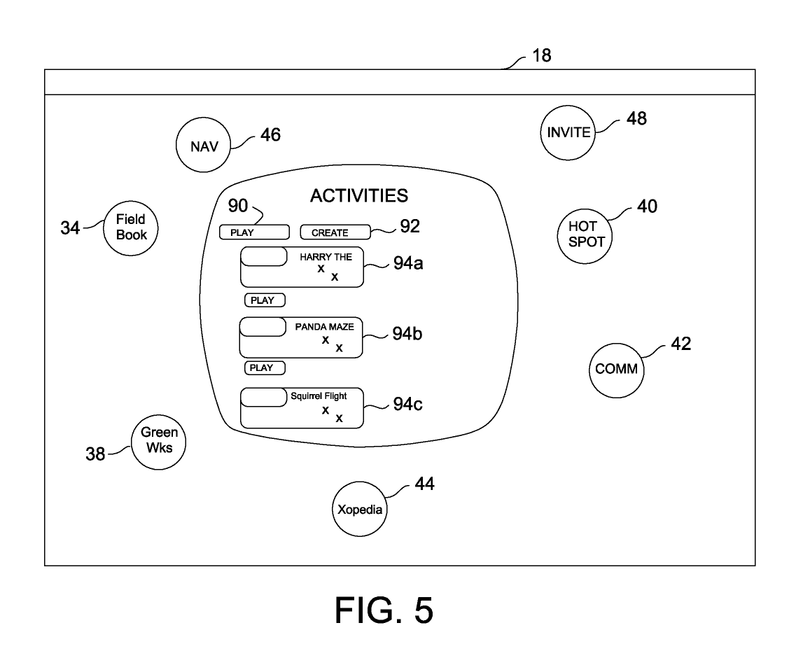

Referring briefly to FIG. 5, the activities component 36 shows and lists the activities which the user has the ability to play at play component 90 or create at create component 92. These include various activity component's 94 a-n.

Discussion of a challenge case scenario as utilized by a particular user “Ricky619” will now be discussed. Ricky 619 logs on as a user to the system and reviews a challenge activity component 70 which was posted by Billy 108. The challenge activity reads as follows “attention all agents, I'm making my first challenge because I love the snake's! (Here is the art from the Viper Xeco-card.) To win this challenge, take a picture of a snake and send it to me. Some places you might find snakes would be in your local science Center or zoo or even your own backyard. Don't get too close to any snakes you find in the wild, especially if you live in rattlesnake country. Bonus points will be awarded for a picture of a shed snakeskin and even more bonus points to anyone who can tell me what is weird about snakes sense of smell.”

Ricky 619 reads the details of the challenge; the first prize is 100 points, second prize is 50 points, and anyone who sends in a photo will get 10 points. In order to be considered for the first and second prizes, the photo has to be date and time stamped. The challenge is set to expire within two weeks.

Ricky 619 knows he need 40 more points to make agent level 2, which will allow him to sponsor a challenge about his favorite eco-card called yellow billed Cotinga. Ricky 619 ponders and remembers that there is a reptile display in his neighborhood library which has an actual snakeskin within it. He also knows there are garter snakes occasionally in his backyard. Over the next week, Ricky 619 goes in the backyard couple of times to look for garter snakes with his big brother. One of these occasions, they see garter snake and Ricky 619 gets a pretty good photo.

Ricky 619 also goes to the library, finds the shed snakeskin and talks to the librarian, convincing her to open the display case so he can get a photo. While at the library, he also looks in the book about snakes and discovers that snakes actually smell with their tongues.

Ricky 619 returns to the challenge page, and sees that 347 people have already submitted their answers. Even still, he feels pretty good about his garter snake picture, his shed skin picture, and he knows answer about snakes sense of smell. Ricky 619 actuates the series of challenge buttons including a “send me your snake” button, a “send me your snakeskin” button, and an “answer the bonus question” button. He pushes the button to submit his snake photo and dialog box walks him through uploading the photo. The photo is automatically resized for submission. He repeats the process with snakeskin photo. And then he enters the answer to the question in a text dialog box. After he is done submitting, a message lets him know that he can check back in six days to determine whether or not he's been selected as a winner.

Therefore I claim:

1. A symbol cipher system comprising:
a. a symbol cipher application for execution on a digital platform, said symbol cipher application comprising: a first group of symbol components; a first range of code entry fields; a cipher correlation table;
b. said cipher correlation table configured to correlate said first group of symbol components to a first range of language characters for entering said first group of symbol components into said first range of code entry fields for registration of a symbol information item in an application database.

2. The system according to claim 1 wherein said symbol information item further comprises a first group of symbol information characters recorded on an item component.

3. The system according to claim 1 wherein said item component further comprises: a digital software component for purchase over the Internet.

4. The system according to claim 1 wherein said item component further comprises: a gift card, a cash card, a debit card, a credit card.

5. The system according to claim 1 wherein said item component further comprises: a digital currency account.

6. The system according to claim 1 wherein said item component further comprises: an identification tag.

7. The system according to claim 1 wherein said item component further comprises: a product registration application.

8. The system according to claim 1 wherein said item component further comprises: a healthcare product.

9. The system according to claim 1 wherein said item component further comprises: a digital widget for use on a social networking site.

10. The system according to claim 1 wherein said item component further comprises: a game console.

11. The system according to claim 1 wherein said item component further comprises: a marketing/promotional campaign.

12. The system according to claim 1 wherein said item component further comprises: a real world product.

13. The system according to claim 1 wherein said system further comprises:
a. a graphic software application configured to generate said first group of symbol components;
b. an item code correlation table maintained in said application database for applying a first group of symbol information characters onto said symbol information item;
c. said symbol information item provided by a symbol information item provider.

14. The system according to claim 13 wherein said symbol information item provider further comprises: a financial institution.

15. The system according to claim 13 wherein said symbol information item provider further comprises: a pharmaceutical maker.

16. The system according to claim 13 wherein said symbol information item provider further comprises: a product manufacturer.

17. The system according to claim 13 wherein said symbol information item provider further comprises: a software provider.

18. The system according to claim 13 wherein said symbol information item provider further comprises: a digital currency provider.

19. The system according to claim 13 wherein said symbol information item provider further comprises: a marketing/advertising provider.

20. The system according to claim 13 wherein said symbol information item provider further comprises: a healthcare provider.

21. The system according to claim 13 wherein said symbol information item provider further comprises: an insurance provider.

22. The system according to claim 13 wherein said symbol information item provider further comprises: a government provider.

23. The system according to claim 13 wherein said symbol information item provider further comprises: a security provider.

24. A method for decoding a symbol information item said method comprising:
a. a user obtaining a symbol information item from a symbol information item provider, said symbol information item comprising a first group of symbol information character components;
b. said user executing a compiled symbol cipher application on a digital platform, and said symbol cipher application comprising a first group of symbol components; a first range of code enter fields; a cipher correlation table for correlating said first group of symbol components with a first range of language characters;
c. said user reading said symbol information characters from said symbol information item;
d. said user entering a first symbol information character into said symbol cipher application by:
i. entering a first symbol component by graphically matching said first symbol information character to said first symbol component;
ii. said user continuing to enter said first group of symbol information characters into said symbol cipher application until said first range of code enter fields are full of a first range of symbol information characters;
iii. transmit a first group of language characters correlated to said first range of symbol information characters, said first group of language characters comprising a secret code.

25. The method according to claim 24 wherein said method further comprises validating said secret code by:
a. looking up said secret code in said application database;
b. matching said secret code to an item code in said application database;
c. returning, if match exists, a validation value for executing platform operations.

26. The method according to claim 25 wherein said executing platform operations further comprises: enabling a registered user to online activities; build social networks; create activities; spend credits or points; access to additional platform information and features.

27. The method according to claim 25 wherein said executing platform operations further comprises: enabling a registered user to utilize digital currency online.

28. A method to code a symbol information item said method comprising:
a. generating a first group of symbol components by using a graphic software application;
b. creating a correlation table in an application database for correlating said first group of symbol characters to a first range of language characters;
c. coding said correlation table into a symbol cipher application;
d. creating item codes and correlating said item codes to symbol information;
e. storing said item codes correlated to said symbol information in said application database;
f. applying said symbol information to a symbol information item;
g. delivering said symbol information item to an end-user.
